(19) United States
(12) Patent Application Publication
(10) Pub. No.: US 2012/0327303 A1
(43) Pub. Date: Dec. 27, 2012

(54) BACKLIT VIDEO DISPLAY WITH DYNAMIC LUMINANCE SCALING

(75) Inventors: Yanfei Sun, Shanghai (CN); Zhong Li He, Austin, TX (US); Chunpeng Lu, Shanghai (CN); Kevin Zhang, Austin, TX (US)

(73) Assignee: FREESCALE SEMICONDUCTOR, INC, Austin, TX (US)

(21) Appl. No.: 13/489,460

(22) Filed: Jun. 6, 2012

(30) Foreign Application Priority Data
Jun. 21, 2011 (CN) 201110189595.6

(51) Int. Cl. H04N 5/57; H04N 5/66

(52) U.S. Cl. 348/687; 348/E05.133; 348/E05.119

(57) ABSTRACT

A method of displaying an image defined by an input video signal on a backlit video device accommodates changes of luminance between successive frames of the input video signal. Changes of luminance distribution, which is a function of a distribution of pixel luminance values in the frames, between the successive frames are detected. Target adjustments to luminance of the backlight and to light transmission of the image panel for a current frame of the input video signal are defined to compensate luminance of the displayed image for the adjustment to luminance of the backlight. Actual adjustments to luminance of the backlight and to light transmission of the image panel for the current frame are functions of the target adjustments for the current frame and of the actual adjustments for a previous frame in proportions, which are a function of the changes detected of luminance distribution between successive frames.

### BACKGROUND OF THE INVENTION

The present invention is directed to backlit video display devices and more particularly to dynamic luminance scaling of a video signal for a backlit video display device to reduce power consumption of the backlit video display device.

In a backlit video display, a backlight panel illuminates an electronically controlled image panel. The backlight panel is of basically uniform brightness, although it may be partitioned so that parts of it can have their brightness controlled separately. The image panel has a matrix of pixel elements whose light transmission is modulated by electronic image input signals to form the image displayed. An example of a backlit display is a backlit liquid crystal display (LCD) in which the pixel matrix comprises liquid crystal material that modifies the polarization of light passing through it as a function of an electric field applied to the pixel. The image panel also includes orthogonal polarizing filters so that the intensity of the light transmitted through the pixel and the polarizing filters is a function of the electric field at each pixel. Examples of LCD image panels are thin-film transistor and active matrix image panels.

The power consumption of the backlight of a display may represent a significant proportion of the total power consumption of a mobile device, up to one third or even half of the total power consumption, for example. It is possible to reduce the backlight power consumption by dimming the backlight (that is to say reducing its luminance) during periods when the image to be displayed is less bright and compensating the backlight dimming by increasing the light transmission of the image panel, a technique known as dynamic luminance scaling (DLS). The adjustment of the luminance of the backlight may be obtained by pulse-width modulation (PWM), for example, in which the instantaneous luminance is maintained, but the proportion of the frame period during which the backlight is illuminated is modulated so as to modulate the average, perceived luminance during the frame. The adjustment of the luminance of the backlight may alternatively be obtained by control of a power management application specific integrated circuit (ASIC), for example.

The range of linearity of light transmission of the image panel is limited, due to saturation of the pixels. Accordingly, for example, if the backlight luminance is insufficient, too many of the pixels of the image panel in the brightest parts of the image may already be at their maximum light transmission, resulting in washout of the image displayed, that is to say lack of contrast in the brighter parts of the image. This limits the acceptable degree of backlight dimming.

It is undesirable if DLS changes of backlight luminance and compensating changes of image panel light transmission to achieve the power saving goal are perceptible as screen flickering, especially of the background parts of the picture, or as non-smooth visual quality.

### BRIEF DESCRIPTION OF THE DRAWINGS

The present invention is illustrated by way of example and is not limited by embodiments thereof shown in the accompanying figures, in which like references indicate similar elements. Elements in the figures are illustrated for simplicity and clarity and have not necessarily been drawn to scale.

FIG. 1 is a schematic side view of a backlit LCD device;

FIG. 2 is a schematic block diagram of a video data processor in accordance with one embodiment of the invention, given by way of example, for driving a backlit display device, such as the LCD backlit device of FIG. 1;

FIG. 3 is a flow chart of a method in accordance with one embodiment of the invention, given by way of example, of processing video signals for driving a backlit display device, such as the LCD backlit device of FIG. 1;

FIG. 4 is a graph of evolution with time of correlation values between histograms of distribution of pixel luminance values between successive frames;

FIG. 5 is a series of histograms showing a change in distribution of luminance during fade in of a scene; and

FIGS. 6 and 7 are examples of video signals obtained with the method of FIG. 3.

### DETAILED DESCRIPTION OF PREFERRED EMBODIMENTS OF THE INVENTION

FIG. 1 shows a conventional backlit LCD device 100. The device 100 comprises a backlight panel 102 whose perceived luminance is a function of a voltage V_{L} and current I_{L} applied to it. The backlight panel 102 may comprise light-emitting diodes (‘LEDs’) whose luminance is a function of the current I_{L}, for example. The adjustment of the luminance of the backlight may be obtained by PWM, for example, or alternatively be obtained by control of a power management ASIC, for example. The device 100 also comprises an image panel comprising an image pixel matrix 104, comprising liquid crystal material, sandwiched between polarizing filters 106 and 108. The polarization directions of the filters 106 and 108 are orthogonal, so that if the image pixel matrix 104 has no effect on the polarization of the light it transmits, the light is blocked by the second polarizing filter 108 and the display is dark. The matrix 104 also comprises sets of row and column electrodes X and Y to which voltages may be applied so as to address individual pixels of the matrix 104. Applying a voltage to an image pixel of the matrix 104 twists the polarization of the light the pixel transmits, which enables light from the backlight 102 transmitted through that pixel to pass also through the second polarizing filter 108 as a function of the magnitude of the voltage applied to the pixel. The device 100 may also include a diffusion panel (not shown) after the second polarizing filter 108 to make the image visible at its surface. The backlit LCD device 100 may display color images in response to video signals comprising luminance and chrominance data.

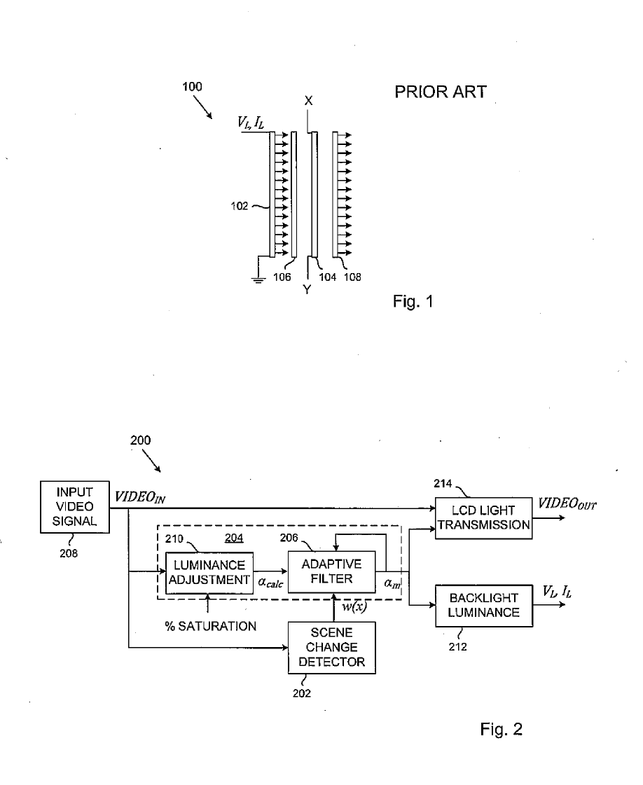

FIG. 2 shows an example of a video data processor 200 in accordance with an embodiment of the invention. The video data processor 200 processes an input video signal VIDEO_{IN} having a series of video frames and provides an output video signal VIDEO_{OUT} for a backlit video device, such as the device 100, comprising a backlight 102 and an image panel comprising a matrix of pixel elements 104. Transmission of light from the backlight 102 by the pixel elements of the matrix 104 is modulated by the output video signal VIDEO_{OUT} to form a displayed image. The video data processor 200 comprises a change detector 202 for detecting changes of luminance distribution between a plurality of frames of the input video signal VIDEO_{IN}, the luminance distribution being a function of a distribution of pixel luminance values in the frames. The video data processor 200 also comprises a dynamic luminance scaling module 204 for defining target adjustments α_{calc} to luminance of the backlight 102 and to light transmission of the image panel 104, 106, 108 for a current frame of the input video signal VIDEO_{IN} to compensate luminance of the image displayed for the adjustment to luminance of the backlight. The dynamic luminance scaling module 204 includes an adaptive filter 206 for applying actual adjustments αₘ to luminance of the backlight 102 and to light transmission of the image panel 104, 106, 108 for the current frame which are functions of the target adjustments α_{calc} for the current frame and of the actual adjustments αₘ for a previous frame in proportions which are a function of the changes of luminance distribution detected by the change detector 202.

In more detail, the input video signal VIDEO_{IN} is provided by an input source 208 and may comprise luminance and chrominance data for individual pixel elements of the matrix 104. The dynamic luminance scaling module 204 includes a luminance adjustment module 210 which defines the target adjustments α_{calc} to luminance of the backlight 102 and to light transmission of the pixel matrix 104 so as to tend to reduce power consumption of the backlight to a value at which a compensating increase in transmission of light by the image panel maintains saturated the light transmission of a defined number of the pixel elements. The actual adjustments αₘ which the adaptive filter 206 generates are applied to vary the voltage V_{L} and current I_{L} for the backlight by a backlight luminance module 212, and are applied as a coefficient by an LCD light transmission module 214 to modify the luminance data of the input video signal VIDEO_{IN} and provide the output video signal VIDEO_{OUT} for the image pixel matrix.

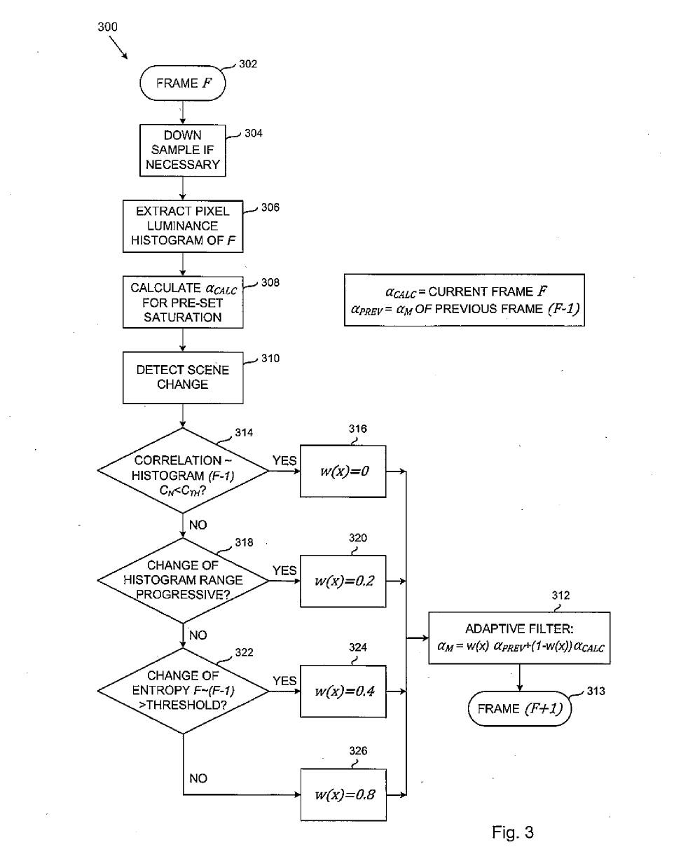

FIG. 3 is a flow chart illustrating an example of a method 300 in accordance with an embodiment of the invention of displaying an image defined by an input video signal VIDEO_{IN}. The method 300 may be implemented in a video data processor such as the processor 200. The method 300 displays the image on a backlit video device, such as the device 100, the backlit video device comprising a backlight 102 and an image panel comprising a matrix of pixel elements 104. Transmission of light from the backlight 102 by the pixel elements of the matrix 104 is modulated to form the displayed image.

The method 300 comprises detecting changes of luminance distribution between a plurality of frames of the input video signal VIDEO_{IN}, the luminance distribution being a function of a distribution of pixel luminance values in the frames. Target adjustments α_{calc} to luminance of the backlight 102 and to light transmission of the image panel 104, 106, 108 for a current frame of the input video signal are defined to compensate luminance of the displayed image for the adjustment to luminance of the backlight. Actual adjustments αₘ to luminance of the backlight 102 and to light transmission of the image panel 104, 106, 108 for the current frame are functions of the target adjustments α_{calc} for the current frame and of the actual adjustments αₘ for a previous frame in proportions which are a function of the changes detected of luminance distribution.

In the processor 200 and the method 300, the changes of luminance distribution are detected between successive frames of the input video signal VIDEO_{IN}. However, it is also possible to detect changes of luminance distribution between a plurality of frames of the input video signal VIDEO_{IN} which are not consecutive. In this example, the actual adjustments αₘ to luminance of the backlight and to light transmission of the image panel for the current frame are substantially equal to the target adjustments α_{calc} for changes of luminance distribution between successive frames which correspond to rapid and/or large changes of scene in the input video signal, known as shot boundaries. However, the actual adjustments αₘ for the current frame are a greater proportion of the actual adjustments αₘ for a previous frame for changes of luminance distribution between successive frames which correspond to slower and/or smaller changes of scene in the input video signal.

In more detail, the method 300 starts for a frame N at 302. At 304, the input video signal VIDEO_{IN} is down sampled if necessary to reduce the quantity of data to be processed by the data processor 200 in calculating the luminance adjustments αₘ, knowing that the full input data of the input video signal VIDEO_{IN} is transferred to the backlit display device 100 in the output video signals VIDEO_{OUT} after scaling by the luminance adjustments αₘ.

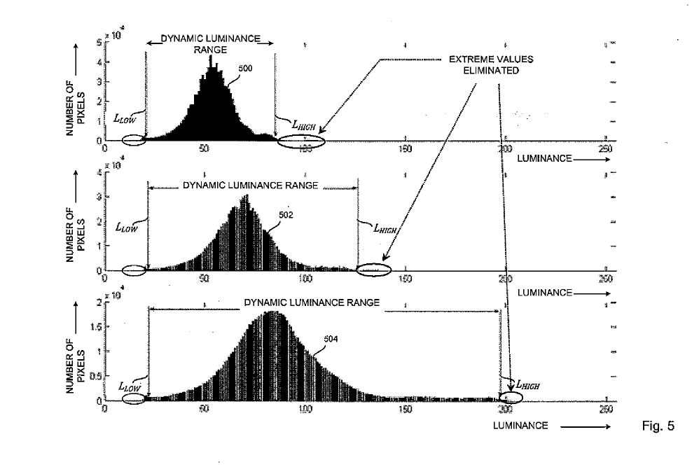

At 306, a distribution of pixel luminance values in the current frame N is calculated. Graphic representations of examples of such distributions of pixel luminance values in different frames are shown in FIGS. 5 at 500, 502 and 504. At 308, target adjustments for the luminance of the backlight panel 102 and compensating adjustments for the transmission of light by the pixels of the matrix 104 in the current frame are calculated. In this example of an embodiment of the invention, the target adjustments for the image panel are a factor α_{calc} multiplying or dividing the luminance component xᵢ of the video signal data for each pixel i of the frame, although the adjustments may be a more complex function. The resulting target adjustment for the light transmission of the pixel matrix 104 is a function f(α_{calc}) of the factor α_{calc}. The corresponding target adjustment for the luminance of the backlight panel 102 is a function 1/f(α_{calc}) of the factor α_{calc}. The adjustments actually applied to the light transmission of the pixel matrix 104 and to the luminance of the backlight panel 102 are derived subsequently from the target adjustments, in steps 310 to 326 described below.

In general, the perceived luminance Lᵢ of the pixel i is given by:

Lᵢ=T(xᵢ)×B

where B is the actual backlight luminance and T(xᵢ) is the light transmission of the pixel i, that is to say the ratio of transmitted luminance to incident luminance. The unadjusted input video signal VIDEO_{IN} defines a perceived luminance (Lᵢ)_{IN} of the pixel i given by:

(Lᵢ)_{IN}=T(xᵢ)_{IN}×B₀

where B₀ is the unadjusted backlight luminance implied by the input video signal VIDEO_{IN}, and T(x)_{IN} is the light transmission that the input video signal VIDEO_{IN} defines for the pixel i. The compensating target adjustments to be made to the luminance of the backlight 102 and to the light transmission of the pixel matrix 104 can be represented as follows:

B_{CALC}=B₀÷f(α_{CALC})

T(xᵢ)_{CALC}=T(xᵢ)_{IN}×f(α_{CALC}), so that

(Lᵢ)_{CALC}=T(xᵢ)_{CALC}×B_{CALC}=(Lᵢ)_{IN},

where B₀ is the unadjusted backlight luminance implied by the input video signal VIDEO_{IN}, B_{CALC} is the adjusted target backlight luminance, T(xᵢ)_{CALC} is the adjusted target luminance data for the pixel i, and (Lᵢ)_{CALC} is the target perceived luminance of the displayed pixel i. The target adjustments f(α_{calc}) for the current frame are chosen in this example to reduce power consumption of the backlight 102 to a value at which a compensating increase in transmission of light by the image panel maintains saturated the light transmission of a defined number of pixels of the matrix 104 in the brightest part of the image to be displayed, causing a degree of wash-out of the contrast of the brightest parts of the image. In this example, the target adjustment factor α_{calc} is chosen to saturate a selected percentage of the pixels, the backlight 102 being dimmed by the corresponding target adjustment 1/f(α_{calc}). In one example, where the range of possible luminance values contains 128 levels, the target adjustment factor α_{calc} is selected so that the pixels in the five brightest levels of the picture saturated.

In this example of an embodiment of the invention, the target adjustments f(α_{calc}) to the light transmission of the pixel matrix 104 are applied by multiplying the luminance component xᵢ of the video signal data for each pixel i of the frame by the chosen factor α_{calc}., so that:

T(xᵢ)_{CALC}=T(xᵢ×α_{CALC}).

Often the light transmission of the pixels of the matrix 104 can be represented approximately as:

T(xᵢ)=M×xᵢ^{N},

where M and N are constant parameters. It then follows that:

$$\begin{matrix}{T ( {x}_{i} )}_{CALC} = T ( {x}_{i} \times {α}_{CALC} ) \\ = M \times {( {x}_{i} \times {α}_{CALC} )}^{N} \\ = ( M \times {x}_{i}^{N} ) \times {α}_{CALC}^{N} \\ = {T ( {x}_{i} )}_{IN} \times {α}_{CALC}^{N} .\end{matrix}$$

### Since

T(xᵢ)_{CALC}=T(xᵢ)_{IN}×f(α_{CALC}), therefore

f(α_{CALC})=α_{CALC}^{N},

and 1/α_{CALC}^{N} is the target adjustment to be applied to the luminance of the backlight 102.

In this example, the actual adjustments αₘ to luminance of the backlight 102 and to light transmission of the image panel 104, 106, 108 for the current frame are smoothed at 312 as a function of the changes detected of luminance distribution between a processor of frames, representing scene changes in the video, which are detected at 310, before repeating the calculations for the next frame at 313. In this example, the actual adjustments αₘ applied to luminance of the backlight 102 and to light transmission of the image panel 104, 106, 108 for the current frame at 312 are a function represented by:

αₘ=w(x)αₚᵣₑᵥ+(1−w(x))α_{calc},

where w(x) is a weighting coefficient whose value is between 0 and 1 and which defines the proportions of the target adjustments for the current frame F and of the actual adjustments for a previous frame (F−1). The value of the weighting coefficient w(x) in this example is a function of the nature of the scene changes in the video, as indicated by the rapidity and/or magnitude of the changes of luminance distribution between a processor of frames detected at 310.

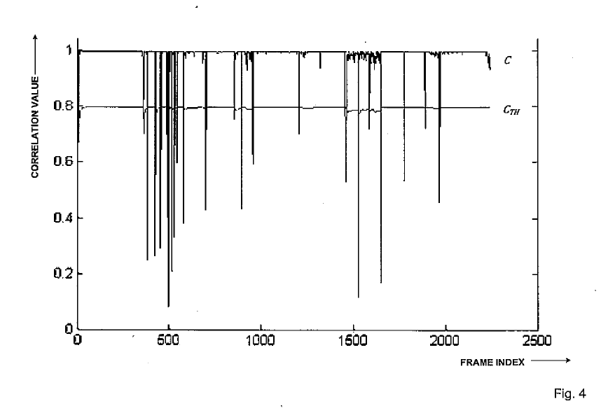

A video shot is defined as a series of interrelated consecutive frames taken contiguously by a single camera and representing a continuous action in time and space. A shot boundary is an abrupt change of scene. When a shot boundary occurs, the viewer's attention will be attracted by the rapid and/or large scene change and he will pay less attention to possible visual quality degradation caused by imperfect compensation of backlight scaling by the image panel transmission. In this example, at 314 the correlation C of histograms of the distribution of pixel luminance values between a current frame F and a previous frame (F−1) is calculated. In this example, C has a value between 0 and 1 and is calculated as C=(2×X×Y)÷(X²+Y²), where X and Y are vectors representing the numbers of pixels in each histogram bin of the luminance distribution of the frames F and (F−1) respectively. A shot boundary is considered to be detected if C is less than a threshold value C_{TH} and the value of the weighting coefficient w(x) is then set to 0 at 316, so that the actual adjustments αₘ are set immediately to the same value as the target adjustments α_{calc} at 312. A typical value of the threshold value C_{TH} in this example is 0.8. FIG. 4 illustrates an example of variation of the correlation value C with time in a sequence of frames. In this example, in order to reduce false detection of shot boundaries by spurious variation of the correlation value C due to ambient light changes or fading or dissolving in the video, the value of the threshold value C_{TH} is decreased for the following frame (F+1) as long as the correlation value C of the current frame F reduces below its maximum but is still greater than the current threshold value C_{TH(F)}, by applying the formula C_{TH(F+1)}=(C_{F}+1)×C_{TH(F)}/2. The threshold value C_{TH(F+1)} is reset to its defined value (0.8 in this example) for the next frame (F+1) when C becomes less than the threshold value C_{TH(F)} during the current frame F indicating a shot boundary has occurred, corresponding to detection of a rapid and/or large change of scene.

Referring again to FIG. 3, a scene change may involve fading in or out or dissolving, during which gradual and progressive transitions occur in the brightness of images in the picture. If no shot boundary is detected at 314, fading or dissolving is detected at 318 by detecting a trend of the dynamic range of frame luminance spreading or shrinking over several successive frames. If such a progressive change in dynamic luminance range is detected at 318, the weighting coefficient w(x) is set at 320, to a value of 0.2 in this example. FIG. 5 illustrates an example of such a progressive trend of the dynamic range of frame luminance. In FIG. 5, the graphs 500, 502 and 504 represent histograms of the distribution of luminance in three frames spaced apart in time by several frames during fading in of an image. It will be seen that the most populated bins of the histograms correspond to successively brighter luminance values as the fade-in progresses. Also, the range of luminance values, that is to say the difference between the maximum and the minimum luminance values in the frame, becomes greater as the fade-in progresses. In this example, the minimum luminance values do not change significantly and the increase of the range of luminance values is due to increase in the maximum luminance values as the fade-in progresses. However, both minimum and maximum values may change in examples of other situations. Fading out is the opposite of fading in and appears as a progressive reduction of the range of luminance values. Dissolving corresponds to fading in of one image accompanied by fading out of another image and may correspond to either a net increase or a net reduction in the range of frame luminance values. If little or no change in the range of frame luminance values is detected at 318, whether because there is no fading or because the dissolving corresponds to little or no net change in the range of frame luminance values, the value of the weighting coefficient w(x) is not set at 320, avoiding risk of luminance adjustments being too perceptible during periods of little change in the image displayed.

In this example, change of the range of the distribution of pixel luminance values between the current frame and previous frames is measured after discarding a defined percentage of pixels having extreme pixel luminance values. In this example, thresholds are set L_{LOW} and L_{HIGH} and pixels having luminance values less than the lower threshold L_{LOW} and pixels having luminance values greater than the upper threshold L_{HIGH} are ignored in calculating the range of the distribution of pixel luminance values in the frame. In this example, the lower threshold L_{LOW} and the upper threshold L_{HIGH} are set so as to eliminate a set proportion of the total number of pixels in the frame, such as 2% for example. The range of the distribution of pixel luminance values is then measured as L_{HIGH}−L_{LOW}−. The pixels eliminated typically result from noise and could have a disproportionate distortional effect on the minimum and maximum values of pixel luminance, and hence on measurement of change of the range of the distribution of pixel luminance values. Noise may be introduced by the image capture process, such as the camera, or by the conversion to electronic signals and encoding/decoding, for example.

Referring again to FIG. 3, if little or no change in the range of frame luminance values is detected at 318, the change E_{N}−E_{N-1} in an entropy value E of the distribution of pixel luminance values between the current frame F and a previous frame (F−1) is calculated at 322. The information entropy for a given frame is given by E=k×Σᵢ₌₀^{i-l-1}(Pᵢ×ln Pᵢ), where Pᵢ is the proportion of pixels which are in the i th histogram bin of a total of I histogram bins and k is a constant. The information entropy E for a given frame is maximal when each luminance bin value has a similar number of pixels in it, and is minimal when all pixels are concentrated in a single histogram bin with no pixels having a different luminance value. In image processing, the entropy E is often calculated anyway, irrespective of dynamic luminance scaling, since it can determine the average code length for lossless image coding. Big differences of entropy E between frames often indicate big motion in the picture or large background/foreground change in a video sequence. If the change E_{F}−E_{F-1} in entropy is greater than a threshold value, such as E_{F-1}*10%, for example, the weighting coefficient w(x) is set at 324, to a value of 0.4 in this example, enabling a moderately progressive adjustment to the backlight luminance. If the change E_{F}-E_{F-1} in entropy is less than the threshold value, no scene change, or only a gradual scene change, is assumed and the weighting coefficient w(x) is set at 326, to a value of 0.8 in this example, imposing the slowest adjustment to the backlight luminance.

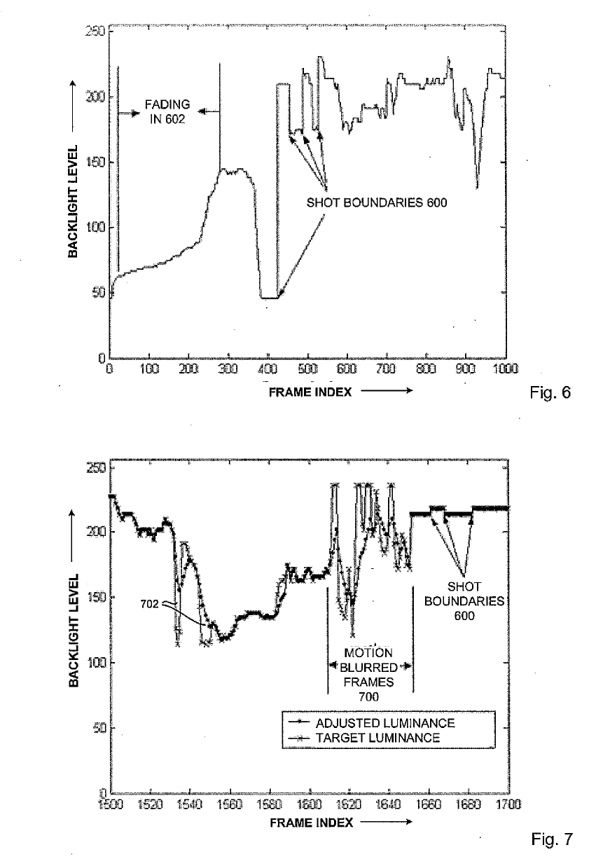

FIGS. 6 and 7 are graphs of the variation with time of the target luminance and the actual luminance of the backlight level for two examples of frame sequences. In FIGS. 6 and 7, the actual luminance of the backlight level changes abruptly with the target luminance at 600, corresponding to detection of low correlation of luminance distribution between two or more successive frames current frame F and F−1 at step 314 and adoption of a value of the weighting coefficient w(x) of 0 at 316. In FIG. 6, the actual luminance of the backlight level changes progressively with the target luminance at 602, corresponding to no detection of a shot boundary at 314, but detection at 318 of a trend of the dynamic range of frame luminance spreading or shrinking over several successive frames and adoption of a value of the weighting coefficient w(x) of 0.2 at 320. In FIG. 7, the actual luminance of the backlight level changes moderately with the target luminance at 700, corresponding to no detection of fading or dissolving at 318, but detection at 322 of a change of entropy value of the distribution of pixel luminance values between the current frame and a previous frame at 322 and adoption of a value of the weighting coefficient w(x) of 0.4 at 324. In FIG. 7, the actual luminance of the backlight level changes only slowly with the target luminance at 700, corresponding to no detection of big motion or background changes at 322, and adoption of a value of the weighting coefficient w(x) of 0.8 at 326.

The saving of backlight power consumption obtained with the data processor 200 and the method 300 are a function of the video sequence being displayed. However, in typical video sequences, a power saving between 20% and 45% has been obtained with satisfactory viewing quality. Since the same adjustments to the transmission of light by the image panel can be applied to all the pixels of the matrix for a whole frame, the dynamic luminance scaling can be performed by modifying color space conversion (‘CSC’) parameters and can be accelerated by hardware such as an image processor unit.

However, the invention may also be implemented at least partially in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

In the foregoing specification, the invention has been described with reference to specific examples of embodiments of the invention. It will, however, be evident that various modifications and changes may be made therein without departing from the broader spirit and scope of the invention as set forth in the appended claims.

The terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Those skilled in the art will recognize that boundaries between the above described operations are merely illustrative. Multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, the examples, or portions thereof, may be implemented as software or code representations of physical circuitry or of logical representations convertible into physical circuitry, such as in a hardware description language.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specification and drawings are, accordingly, to be regarded as illustrative rather than restrictive.

In the claims, the word ‘comprising’ does not exclude the presence of other elements or steps then those listed in a claim. The terms “a” or “an,” as used herein, are defined as one or more than one. The use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The fact that certain measures are recited in mutually different claims does not indicate that a combination of these measures cannot be used to advantage.

1. A video data processor for processing an input video signal comprising a series of video frames and providing an output video signal for a backlit video device, wherein said backlit video device includes a backlight and an image panel comprising a matrix of pixel elements whose transmission of light from said backlight is modulated by said output video signal to form a displayed image, said video data processor comprising:
a change detector for detecting changes of luminance distribution between a plurality of frames of said input video signal, said luminance distribution being a function of a distribution of pixel luminance values in said frames; and
a dynamic luminance scaling module for defining target adjustments to luminance of said backlight and to light transmission of the image panel for a current frame of said input video signal to compensate luminance of the image displayed for said adjustment to luminance of said backlight;
wherein said dynamic luminance scaling module includes an adaptive filter for applying actual adjustments to luminance of said backlight and to light transmission of the image panel for said current frame which are functions of said target adjustments for said current frame and of said actual adjustments for a previous frame in proportions which are a function of said changes of luminance distribution detected by said change detector.

2. The video data processor of claim 1, wherein said actual adjustments to luminance of said backlight and to light transmission of the image panel for said current frame are substantially equal to said target adjustments for changes of luminance distribution between successive frames which correspond to rapid and/or large changes of scene in said input video signal, and said actual adjustments for said current frame are a greater proportion of said actual adjustments for a previous frame for changes of luminance distribution between successive frames which correspond to slower and/or smaller changes of scene in said input video signal.

3. The video data processor of claim 1, wherein said actual adjustments to luminance of said backlight and to light transmission of the image panel for said current frame are a function of a variable αₘ represented by αₘ=w(x)αₚᵣₑᵥ+(1−w(x))α_{calc}, where α_{calc} is said target adjustment for a current frame, αₘ is said actual adjustment for a previous frame and w(x) is a weighting coefficient whose value is between 0 and 1 and which defines said proportions of said target adjustments for said current frame and of said actual adjustments for a previous frame.

4. The video data processor of claim 1, wherein the value of said weighting coefficient w(x) is a function of rapidity and/or magnitude of said changes of luminance distribution between a plurality of frames of said input video signal.

5. The video data processor of claim 1, wherein said target adjustment to luminance of said backlight reduces power consumption of said backlight to a value at which a compensating increase in transmission of light by said image panel maintains saturated the light transmission of a defined number of said pixel elements.

6. The video data processor of claim 1, wherein said change detector detecting said changes of luminance distribution between a plurality of frames includes measuring a statistical correlation value of said distribution of pixel luminance values between said current frame and a previous frame relative to a threshold value to detect a rapid and/or large change of scene.

7. The video data processor of claim 6, wherein said change detector decreases said threshold value from one frame to the next as long as said statistical correlation value is less than a maximum value and greater than said threshold value, and resets said threshold value to a defined value when said statistical correlation value becomes less than said threshold value corresponding to detection of a rapid large change of scene.

8. The video data processor of claim 1, wherein said change detector detecting said changes of luminance distribution between a plurality of frames includes measuring change of a range of said distribution of pixel luminance values between said current frame and previous frames to detect a progressive change of scene.

9. The video data processor of claim 8, wherein said change detector measures said change of a range of said distribution of pixel luminance values between said current frame and previous frames after discarding a defined percentage of pixels having extreme pixel luminance values.

10. The video data processor of claim 1, wherein said change detector detecting said changes of luminance distribution between a plurality of frames includes measuring a change in an entropy value of said distribution of pixel luminance values between said current frame and a previous frame.

11. A method of displaying on a backlit video device an image defined by an input video signal, wherein the backlit video device includes a backlight and an image panel comprising a matrix of pixel elements whose transmission of light from the backlight is modulated to form the displayed image, the method comprising:
detecting changes of luminance distribution between a plurality of frames of said input video signal, wherein the luminance distribution is a function of a distribution of pixel luminance values in the plurality of frames; and
defining target adjustments to luminance of the backlight and to light transmission of the image panel for a current frame of said input video signal to compensate luminance of the displayed image for said adjustment to luminance of the backlight;
wherein actual adjustments to luminance of the backlight and to light transmission of the image panel for said current frame are functions of said target adjustments for said current frame and of said actual adjustments for a previous frame in proportions that are a function of said detected changes of luminance distribution.

12. The method of claim 11, wherein said actual adjustments to luminance of the backlight and to light transmission of the image panel for said current frame are substantially equal to said target adjustments for changes of luminance distribution between successive frames that correspond to at least one of rapid and large changes of scene in said input video signal, and said actual adjustments for said current frame are a greater proportion of said actual adjustments for a previous frame for changes of luminance distribution between successive frames that correspond to at least one of slower and smaller changes of scene in said input video signal.

13. The method of claim 11, wherein said actual adjustments to luminance of said backlight and to light transmission of the image panel for said current frame are a function of a variable αₘ represented by αₘ=w(x)αₚᵣₑᵥ+(1−w(x))α_{calc}, where α_{calc} is said target adjustment for a current frame, αₘ is said actual adjustment for a previous frame and w(x) is a weighting coefficient whose value is between 0 and 1 and that defines said proportions of said target adjustments for said current frame and of said actual adjustments for a previous frame.

14. The method of claim 13, wherein the value of said weighting coefficient w(x) is a function of rapidity and/or magnitude of said changes of luminance distribution between a plurality of frames of input video signal.

15. The method of claim 11, wherein said target adjustment to luminance of the backlight reduces power consumption of the backlight to a value at which a compensating increase in transmission of light by said image panel maintains saturated the light transmission of a defined number of said pixel elements.

16. The method of claim 11, wherein detecting said changes of luminance distribution between a plurality of frames includes measuring a statistical correlation value of said distribution of pixel luminance values between said current frame and a previous frame relative to a threshold value to detect a rapid and/or large change of scene.

17. The method of claim 13, wherein said threshold value decreases from one frame to the next as long as said statistical correlation value is less than a maximum value and greater than said threshold value, and resets said threshold value to a defined value when said statistical correlation value becomes less than said threshold value corresponding to detection of said rapid and/or large change of scene.

18. The method of claim 11, wherein detecting said changes of luminance distribution between a plurality of frames includes measuring change of a range of said distribution of pixel luminance values between said current frame and previous frames to detect a progressive change of scene.

19. The method of claim 18, wherein said change of a range of said distribution of pixel luminance values between said current frame and previous frames is measured after discarding a defined percentage of pixels having extreme pixel luminance values.

20. The method of claim 11, wherein detecting said changes of luminance distribution between said plurality of frames includes measuring a change in an entropy value of said distribution of pixel luminance values between said current frame and a previous frame.
